(19) United States
(12) Patent Application Publication
(10) Pub. No.: US 2020/0065895 A1
(43) Pub. Date: Feb. 27, 2020

(54) INTELLIGENT RESOURCE DEPLOYMENT COUNTEROFFER SYSTEM

(71) Applicant: BANK OF AMERICA CORPORATION, Charlotte, NC (US)

(72) Inventors: Andrew Benjamin Glassman, Charlotte, NC (US); Terry Lee Castonguay, II, Charlotte, NC (US); Raymond Casey Celli, Charlotte, NC (US); Susan Michelle Feinberg, Vemon, CT (US); Jose Ruiz, Charlotte, NC (US); Peter James Strawser, Odessa, FL (US); Susan Elaine Wright, Tujunga, CA (US)

(73) Assignee: BANK OF AMERICA CORPORATION, Charlotte, NC (US)

(21) Appl. No.: 16/109,037

(22) Filed: Aug. 22, 2018

(51) Int. Cl. G06Q 40/02; H04L 29/08

(52) U.S. Cl. CPC G06Q 40/025; H04L 67/306

(57) ABSTRACT

Systems, computer program products, and methods are described herein for an intelligent resource deployment counteroffer system. The present invention is configured to receive a request for one or more additional resources to be deployed to the user; retrieve information associated with a resource utilization profile associated with the user; determine that a deployment of the one or more additional resources to the user will exceed the resource capacity; initiate one or more optimization algorithms on the resource utilization profile, the one or more additional resources, and one or more alternative resources to determine at least one favorable alternative resource to the one or more additional resources; determine a counteroffer associated with the deployment of the one or more additional resources based on at least determining the at least one favorable alternative resource; and display the counteroffer to the user.

### FIELD OF THE INVENTION

The present invention embraces a system for intelligent resource deployment counteroffer system.

### BACKGROUND

Entities deploy additional resources based on specific qualification criteria. While the requirements to receive additional resources are fixed, the variables used in determining the qualification criteria may vary substantially. In situations where a user does not meet the qualification criteria, there is a need for an intelligent system to find alternate resources that can look across a multitude of variables efficiently, and in a short period of time to determine a counteroffer with a favorable alternate resource for the user.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for an intelligent resource deployment counteroffer system is presented. The system comprising at least one non-transitory storage device; and at least one processing device coupled to the at least one non-transitory storage device, wherein the at least one processing device is configured to: electronically receive, from a computing device associated with a user, a request for one or more additional resources to be deployed to the user; retrieve information associated with a resource utilization profile associated with the user, wherein the resource utilization profile comprises a resource capacity; determine that a deployment of the one or more additional resources to the user will exceed the resource capacity; initiate one or more optimization algorithms on the resource utilization profile, the one or more additional resources, and one or more alternative resources to determine at least one favorable alternative resource to the one or more additional resources; determine a counteroffer associated with the deployment of the one or more additional resources based on at least determining the at least one favorable alternative resource; and transmit control signals configured to cause the computing device associated with the user to display the counteroffer to the user.

In some embodiments, the at least one processing device is further configured to: electronically receive, from the computing device, the request for one or more additional resources to be deployed to the user, wherein the one or more additional resources comprises at least a new line of credit with a first entity, wherein the new line of credit comprises at least a line amount and an interest rate; receive information associated with the resource utilization profile of the user, wherein the resource utilization profile comprises at least an existing line of credit of the user with one or more entities, an annual income of the user, and assets and liabilities of the user; and determine the resource capacity of the user based on at least the information associated with the resource utilization profile of the user, wherein determining the resource capacity further comprises determining a lending score associated with the user, wherein the lending score is indicative of an eligibility of the user to receive the new line of credit.

In some embodiments, the at least one processing device is further configured to: determine based on at least the lending score, that the user is not eligible to receive the new line of credit with the first entity, wherein determining further comprises comparing the lending score of the user with a predetermined eligibility score; receive information associated with the one or more alternative resources, wherein the one or more alternative resources comprises at least one of an alternative line of credit, wherein the alternative line of credit comprises at least an alternative line amount and an alternative interest rate; and initiate the one or more optimization algorithms on the information associated with the resource utilization profile of the user, the one or more alternative resources, and information associated with the new line of credit to determine at least one favorable alternative line of credit to the new line of credit, wherein the at least one favorable alternative line of credit comprises an optimal alternative line of credit for the user.

In some embodiments, the one or more optimization algorithms are configured to determine the optimal alternative line of credit by minimizing the alternative interest rate and maximizing the alternative line amount while keeping the lending score lower than the predetermined eligibility score to determine an optimal alternative line amount and an optimal alternative interest rate.

In some embodiments, the at least one processing device is further configured to determine a first set of actions to be executed by the user to receive the optimal alternative line amount at the optimal alternative interest rate.

In some embodiments, the first set of actions comprises at least paying off at least a portion of the existing line of credit.

In some embodiments, the at least one processing device is further configured to: electronically receive, from the computing device of the user, an indication that the user has executed at least a portion of the first set of actions; determine the lending score of the user based on at least receiving the indication that the user has executed at least the portion of the first set of actions; determine whether the lending score of the user is greater than the predetermined eligibility score; and determine that the user is eligible to receive the optimal alternative line amount at the optimal alternative interest rate based on at least determining that the lending score of the user is greater than the predetermined eligibility score.

In some embodiments, the at least one processing device is further configured to: electronically receive, from the computing device of the user, a preferred interest rate for the optimal alternative line amount; initiate the one or more optimization algorithms on the information associated with the resource utilization profile of the user, the one or more alternative resources, and the preferred interest rate to determine the optimal alternative line of credit for the user, wherein the optimal alternative line of credit comprises the optimal alternative line amount and the preferred interest rate; and determine a second set of actions to be executed by the user to receive the optimal alternative line amount at the preferred alternative interest rate, wherein the second set of actions comprises at least paying off a portion of the existing line of credit.

In some embodiments, the at least one processing device is further configured to: electronically receive, from the computing device of the user, an indication that the user has executed at least a portion of the second set of actions; determine the lending score of the user based on at least receiving the indication that the user has executed at least the portion of the second set of actions; determine whether the lending score of the user is greater than the predetermined eligibility score; and determine that the user is eligible to receive the optimal alternative line amount at the preferred alternative interest rate based on at least determining that the lending score of the user is greater than the predetermined eligibility score.

In some embodiments, the at least one processing device is further configured to: electronically receive, from the computing device of the user, a preferred set of actions the user is willing to execute to receive the new line of credit; determine the lending score of the user based on at least receiving the preferred set of actions the user is willing to execute to receive the new line of credit; determine whether the lending score of the user is greater than the predetermined eligibility score; and determine that the user is not eligible to receive the new line of credit based on at least determining that the lending score of the user is not greater than the predetermined eligibility score.

In some embodiments, the at least one processing device is further configured to initiate, based on at least receiving the indication that the user is willing to execute the preferred set of actions, the one or more optimization algorithms on the information associated with the resource utilization profile of the user, the one or more alternative resources, and information associated with the new line of credit to determine the optimal alternative line of credit for the user, wherein the optimal alternative line of credit comprises the optimal alternative line amount and the optimal alternative interest rate.

In some embodiments, the at least one processing device is further configured to initiate a presentation of a user interface for display on the computing device of the user, wherein the user interface comprises the counteroffer, wherein the counteroffer further comprises the optimal alternative line of credit.

In another aspect, a computer program product for an intelligent resource deployment counteroffer system is presented. The computer program product comprising a non-transitory computer-readable medium comprising code causing a first apparatus to: electronically receive, from a computing device associated with a user, a request for one or more additional resources to be deployed to the user; retrieve information associated with a resource utilization profile associated with the user, wherein the resource utilization profile comprises a resource capacity; determine that a deployment of the one or more additional resources to the user will exceed the resource capacity; initiate one or more optimization algorithms on the resource utilization profile, the one or more additional resources, and one or more alternative resources to determine at least one favorable alternative resource to the one or more additional resources; determine a counteroffer associated with the deployment of the one or more additional resources based on at least determining the at least one favorable alternative resource; and transmit control signals configured to cause the computing device associated with the user to display the counteroffer to the user.

In yet another aspect, a computer implemented method for an intelligent resource deployment counteroffer system is presented. The method comprising: electronically receiving, from a computing device associated with a user, a request for one or more additional resources to be deployed to the user; retrieving, using a computing device processor, information associated with a resource utilization profile associated with the user, wherein the resource utilization profile comprises a resource capacity; determining, using a computing device processor, that a deployment of the one or more additional resources to the user will exceed the resource capacity; initiating, using a computing device processor, one or more optimization algorithms on the resource utilization profile, the one or more additional resources, and one or more alternative resources to determine at least one favorable alternative resource to the one or more additional resources; determining, using a computing device processor, a counteroffer associated with the deployment of the one or more additional resources based on at least determining the at least one favorable alternative resource; and transmitting, using a computing device processor, control signals configured to cause the computing device associated with the user to display the counteroffer to the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for intelligent resource deployment counteroffer system, in accordance with an embodiment of the invention, in accordance with an embodiment of the invention;

FIG. 2 illustrates a process flow for an intelligent resource deployment counteroffer system, in accordance with an embodiment of the invention; and

FIG. 3 illustrates a snapshot of a user interface associated with an application configured to execute an optimization algorithm, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As used herein, a “user” may be an individual associated with an entity. In some embodiments, a “user” may be an employee (e.g., a developer, a coder, an architect, an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer.

As used herein, a “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, to “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information.

As used herein, an “interaction” may refer to any communication between one or more users, one or more entities or institutions, and/or one or more devices, nodes, clusters, or systems within the system environment described herein. For example, an interaction may refer to a transfer of data between devices, a accessing of stored data by one or more nodes of a computing cluster, a transmission of a requested task, or the like.

As used herein, the term “resource” will generally refer to hardware devices, software applications, objects, products, goods, commodities, services, and the like, and/or the ability and opportunity to access and use the same. Some example implementations herein contemplate one or more accounts, a line of credit associated with the one or more accounts including, but not limited to, demand loan, special purpose, export packing credit, term loan, discounting, purchase of commercial bills, traditional revolving credit card account, or the like. Examples of resources associated with accounts may be accounts that have cash or cash equivalents, commodities, and/or accounts that are funded with or contain property, such as safety deposit boxes containing jewelry, art or other valuables, a trust account that is funded with property, or the like. Examples of resources that may not necessarily be associated with accounts may be particularized goods, such as, devices, equipment, or other valuables, or the like. Similarly, “funds” or “available balance” refer to types of resources. For example, the term “fund” may be used to refer to one or more sets of monetary resources available to a user, and may also be referred to as an available balance, a collected balance, good funds, and usable funds.

Many of the embodiments and example implementations thereof described herein are directed toward solving a pervasive technical problem that consumers at all levels, from individuals to global enterprises, have long encountered, namely, the effective deployment and accessing of resources across disparate systems. Typically, resources are deployed to a user based on an existing resource utilization profile associated with each user. The resource utilization profile provides, among other things, a snapshot of the number of resources currently being accessed by the user, and a resource capacity. Many example implementations of the invention contemplate analyzing the resource utilization profile of the user to determine a resource capacity when determining additional resources to be deployed to the user. In cases where the deployment of the additional resources exceeds the resource capacity associated with the resource utilization profile of the user, the example embodiments and implementations of the invention transforms the resource deployment process into an optimization problem, and executes optimization algorithms to select one or more favorable resources from a set of available alternatives to be provided to the user as a counteroffer. By implementing optimization algorithms on the resource deployment process, the present invention provides the functional benefit of varying decision variables to determine the most favorable alternate resource from a set of available alternate resources.

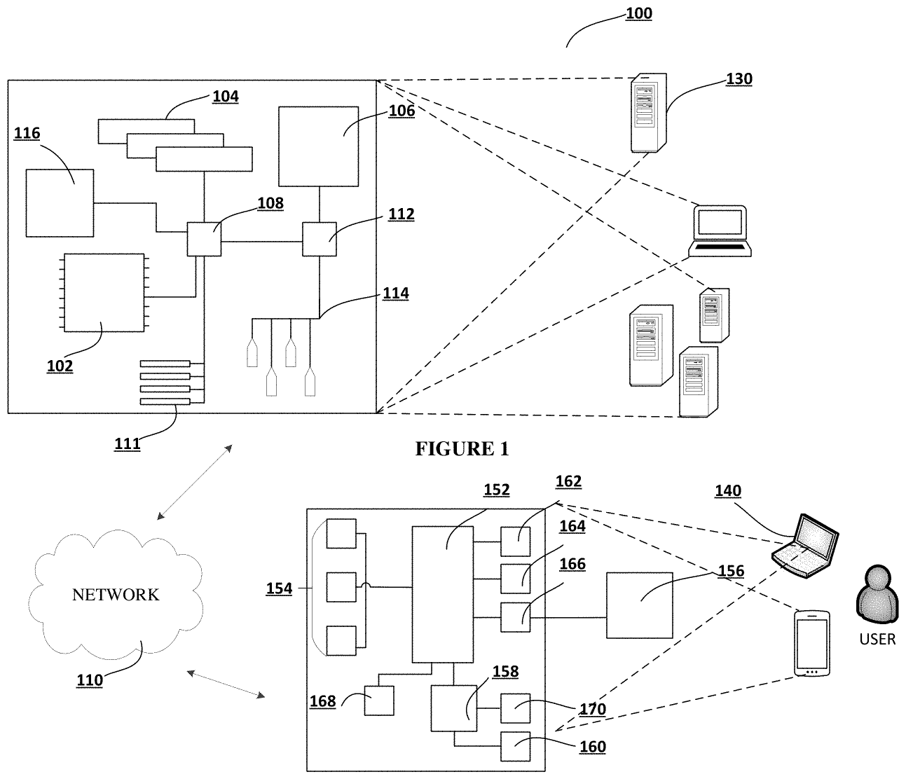

FIG. 1 presents an exemplary block diagram of the system environment for intelligent resource deployment counteroffer system 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute one or more applications stored thereon. The one or more applications may be configured to communicate with the system 130, perform a transaction, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, personal digital assistants, servers, blade servers, mainframes, and other appropriate computers. The user input system 140 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by the business. The system 130 may be located at the facility associated with the business or remotely from the facility associated with the business.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 1408 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flows described herein. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation - and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

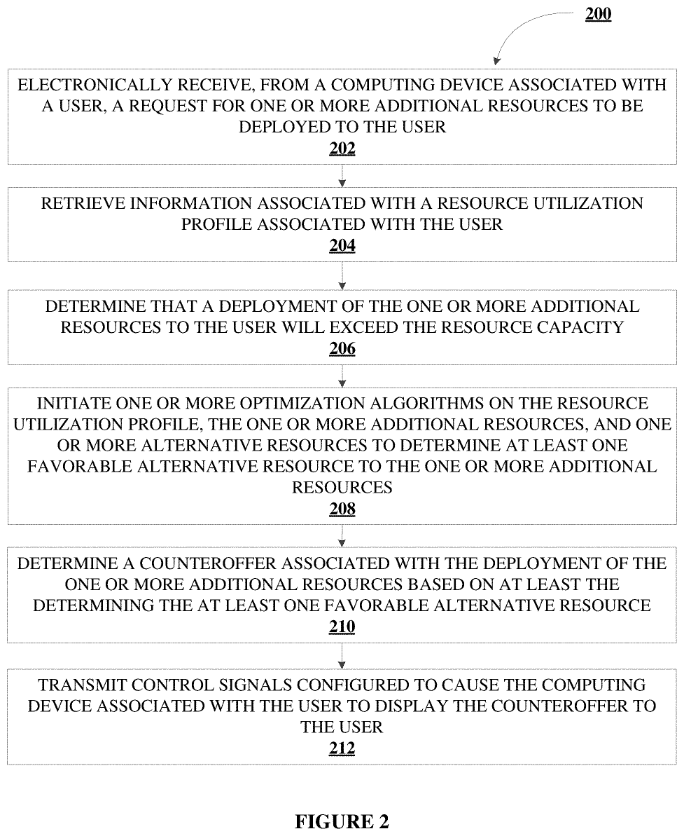

FIG. 2 illustrates a process flow for an intelligent resource deployment counteroffer system 200, in accordance with an embodiment of the invention. As shown in block 202, the process flow includes electronically receiving, from a computing device associated with a user, a request for one or more additional resources to be deployed to the user. In this regard, the system may be configured to establish a communication link with the computing device of the user to create a data channel with the computing device. This enables the system to facilitate the transmission and reception of data packets to and from the computing device. In some embodiments, the request comprises an implicit authorization to access one or more resources currently being accessed and/or associated with the user. In this regard, the computing device of the user may be configured to embed, within the request, an authorization code to enable access to the one or more resources. In response to receiving the request, the system may be configured to enable an associate to access the one or more resources associated with the user without requiring additional authorization. In some other embodiments, access to the one or more resources may require authorization.

As described herein, a resource may indicate assets and liabilities of the user. The user's assets may include but are not limited to checking accounts, savings accounts, investment accounts (e.g., with regular disbursements and penalties for principal withdrawals, or self-directed accounts that more liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash in a couple of days without penalty). In one aspect, the process flow includes determining a user's asset values (e.g., balances of the account, current or estimated future fair market values of the property, or the like) and liability values (e.g., amount owed, or the like). The user's liabilities may include a mortgage, long and short term debit, payments owed on other personal property or legal judgments against the user, or the like). In some embodiments all of the assets and liabilities are determined in order to get an idea of what the values of the assets and liabilities are in order to determine how long the inflows and outflows for the user may last. The fund in-flows include funds received from or deposited into the user's assets (e.g., user's accounts, or the like), such as paychecks, 401K disbursements, pension disbursements, or the like. The fund out-flows include past outflows of funds from the user's assets (e.g., user's accounts, or the like) are determined, such as payments for housing (e.g., rent or mortgage), bills, health care insurance and other costs, heat, water, food, or like, which illustrates all of the essential (e.g., necessary or necessary to the user) costs that cover what the user currently uses to live. Accordingly, the one or more additional resources comprises at least a new line of credit for the user with an entity. In one aspect, the new line of credit comprises at least a line amount and an interest rate.

Next, as shown in block 204, the process flow includes retrieving information associated with a resource utilization profile associated with the user. In some embodiments, the resource utilization profile may include one or more resources allocated to and/or currently being accessed by the user. As described herein, the system may be configured to provide an associate with authorized access to the one or more resources. In this regard, the system may be configured to receive one or more authentication credentials from the associate and validate the one or more authentication credentials to enable the associate to access the one or more resources associated with the user. Examples of authentication credentials include, but are not limited to, username, contact information, a password, a PIN number, biometric information (e.g., physiological features such as fingerprints, finger vein and palm vein patterns, as well as iris and facial recognition to verify individual identities), a unique identification number associated with the user, social network information, an account number, or a card number. In some embodiments, the user information may be proprietary to the entity, such as an account number, a reference number to an account, a client number, or the like. In other embodiments, the user information may be public information, such as a phone number, mailing address, email address, or the like.

In some embodiments, the resource utilization profile further comprises a user profile associated with the user. Among other things, the user profile includes an age of the user and a lifestyle of the user. In one aspect, the user profile may be determined based on at least one or more past transactions of the user, a geographic location of the user, an income level, an amount of outgoing funds, asset values, liability values, asset types, spending habits, saving habits or the like. In one aspect, the user profile includes at least information identifying the user. In some embodiments, the system may be configured to establish predefined user profiles including, but not limited to travel profiles, homebody, luxury spender, thrifty saver, risk taker, or the like.

In some embodiments, the resource utilization profile comprises a resource capacity. In one aspect, the resource capacity may define a maximum limit associated with the amount of resources that the user can be associated with at a particular time. In some embodiment, the resource capacity may define a maximum limit associated with the amount of resources the user can access at a particular time. In yet another embodiment, the resource capacity may define a maximum limit associated with the amount of resources that can be deployed to the user. In one aspect, a resource capacity may include a one or more industry standard specifications that establish a limit associated with a new line of credit available to the user. For example, in the context of home loans, the loan-to-value (LTV) is the ratio between the new line amount requested by the user and the value of the home. In another example, debt-to-income (DTI) is the amount of recurring debt compared to the gross income of the user. DTIs typically include both a front-end ratio and a back-end ratio. The front-end ratio includes an anticipated periodic mortgage payment plus other periodic costs of home ownership. Other costs of homeownership could include homeowner association (HOA) fees, property taxes, mortgage insurance and homeowner's insurance. The back-end ratio includes a total debt ratio comprising other installments and revolving debts of the user. Such information may typically be retrieved from the credit report of the user. These payments may be determined from the assets and liabilities of the user. Other resource capacity parameters include a Fair Isaac Corporation (FICO) score, debt-to-income limits, or the like. While certain resource capacity parameters such as FICO tend to be fixed during the process of the user requesting and subsequently obtaining a new line of credit, other parameters such as DTI and LTV ratios may vary substantially depending on debts, payoffs, loan amounts, or the like. Accordingly, the resource utilization profile includes, but is not limited to, at least an existing line of credit of the user with one or more entities, an annual income of the user, and the assets and liabilities of the user.

Next, as shown in block 206, the process flow includes determining that a deployment of the one or more additional resources to the user will exceed the resource capacity. In some embodiments, the resource capacity may include a predetermined eligibility score. In one aspect, the system may be configured to determine a lending score of the user that is indicative of an eligibility of the user to receive the new line of credit. In some embodiments, the lending score may be determined based on at least analyzing one or more variables such as DTI, LTV, FICO, individually, or in combination, to represent the creditworthiness of the user. If the current lending score of the user is greater than a predetermined eligibility score, the user may not be eligible to receive the new line of credit. On the other hand, if the current lending score of the user is lower than the predetermined eligibility score, the user may be eligible to receive the new line of credit. In some embodiments, the system may be configured to determine a new lending score of the user based on at least extending the new line of credit to the user. In response, the new lending score is compared to the predetermined eligibility score to determine whether the user is eligible to receive the new line of credit. In response to determining that the user is not eligible to receive the new line of credit, the system may be configured to receive information associated with the one or more alternative resources. In some embodiments, the one or more alternative resources includes at least one of an alternative line of credit comprising at least an alternative line amount and an alternative interest rate.

Next, as shown in block 208, the process flow includes initiating one or more optimization algorithms on the resource utilization profile, the one or more additional resources, and one or more alternative resources to determine at least one favorable alternative resource to the one or more additional resources. In this regard, the system may be configured to formulate the resource deployment process into an optimization model. In doing so, the resource deployment process is represented using decision variables and seek values that maximize (or minimize) objective functions of the decision variables subject to constraints on variable values expressing the limits on possible decision choices. In one aspect, the decision variables include independent variables and dependent variables. Typically, independent variables are those whose values can be changed independently to modify the behavior of the system. Examples of independent variables include, but is not limited to, an income of the user, a line amount associated with an existing line of credit, value of the home, an interest rate associated with the new line of credit, a line amount associated with the new line of credit, or the like. Dependent variables are those whose behavior is determined by the values selected for the independent variables. Examples of dependent variables include, but are not limited to, DTI, LTV, or the like. In some embodiments, constraints of optimization models specify the restrictions and interactions, other than variable bounds, that limit decision variable values. Examples of constraints include, but are not limited to, an interest rate, a maximum line amount, a minimum line amount, or the like.

In some embodiments, the one or more optimization algorithms may be initiated on the resource utilization profile of the user, the one or more alternative resources, and information associated the new line of credit to determine at least one favorable alternative line of credit to the new line of credit, and a set of actions to be executed by the user to receive the at least one favorable alternative line of credit. In one aspect, the at least one favorable alternative line of credit includes an optimal line of credit for the user. In some embodiments, the one or more optimization algorithms are configured to determine the optimal alternative line of credit by minimizing the alternative interest rate and maximizing the alternative line amount while keeping the lending score lower than the predetermined eligibility score to determine an optimal alternative line amount, an optimal alternative interest rate, and the set of actions. In one aspect, the system may be configured to receive, from the computing device of the user, a preferred interest rate for the optimal alternative line amount. Accordingly, when the optimization algorithms are executed on the information associated with the resource utilization profile of the user, the one or more alternative resources, and the preferred interest rate to determine the optimal alternative line of credit for the user, they may be configured to constrain the optimal alternative interest rate to the preferred interest rate. The resulting optimal alternative line of credit includes an optimal alternative line of credit at the preferred interest rate.

Next, as shown in block 210, the process flow includes determining a counteroffer associated with the deployment of the one or more additional resources based on at least determining the at least one favorable alternative resource. In some embodiments, the counteroffer includes the optimal alternative line of credit and a first set of actions to be executed by the user to receive the optimal alternative line amount at the optimal alternative interest rate. In one aspect, the first set of actions comprises at least paying off at least a portion of the existing line of credit. For example, if the user has three existing lines of credit associated with his/her resource utilization profile, the first set of actions may include paying off at least one existing line of credit or paying off at least a portion of each of the three existing lines of credit. In one aspect, paying off at least a portion of the existing line of credit may be categorized based on a desired payoff scenario and an optional payoff scenario. In one aspect, the desired payoff scenario indicates at least a portion of the existing line of credit that must be paid off. In yet another aspect, the desired payoff scenario indicates at least a portion of the existing line of credit that must not be paid off. For example, if an existing line of credit is a 30 year mortgage loan with an entity, and the new line of credit is an auto loan, the 30 year mortgage loan may be indicated as an existing line of credit that must not be paid off to receive the new line of credit. In another aspect, the optional payoff scenario indicates at least a portion of the existing line of credit that may be a combination of at least a portion of the existing line of credit that must be paid off, a portion of the existing line of credit that must not be paid off, and a portion of the existing line of credit that can optionally be paid off.

In some embodiments, the system may be configured to electronically receive, from the computing device of the user, an indication that the user has executed at least a portion of the first set of actions. In response, the system may be configured to determine the lending score of the user. The determined lending score is then compared with the predetermined eligibility score to determine whether the lending score of the user is greater than the predetermined eligibility score. Accordingly, the system may be configured to determine that the user is eligible to receive the optimal alternative line amount at the optimal alternative interest rate based on at least determining that the lending score of the user is greater than the predetermined eligibility score.

In embodiments where the user has provided a preferred interest rate, the system may be configured to determine a second set of actions to be executed by the user to receive the optimal alternative line amount at the preferred alternative interest rate. In some embodiments, the system may be configured to electronically receive, from the computing device of the user, an indication that the user has executed at least a portion of the second set of actions. In response, the system may be configured to determine the lending score of the user. The determined lending score is then compared with the predetermined eligibility score to determine whether the lending score of the user is greater than the predetermined eligibility score. Accordingly, the system may be configured to determine that the user is eligible to receive the optimal alternative line amount at the preferred interest rate based on at least determining that the lending score of the user is greater than the predetermined eligibility score.

In some embodiments, the system may be configured to electronically receive, from the computing device of the user, a preferred set of actions the user is willing to execute to receive the new line of credit. In one aspect, the preferred set of actions may include at least paying off at least a portion of the existing line of credit. For example, the user may be willing to pay off at least a portion of the each of the user's existing line of credit or pay off at least one existing line of credit. In such scenarios, the system may be configured to initiate the one or more optimization algorithms to constrain the algorithm based on the preferred set of actions and determine an optimal alternative line of credit for the user accordingly.

Next, as shown in block 212, the process flow includes transmitting control signals configured to cause the computing device associated with the user to display the counteroffer to the user. In this regard, the system may be configured to initiate a presentation of a user interface for display on the computing device of the user, wherein the user interface comprises the counteroffer, where the counteroffer includes the optimal alternative line of credit.

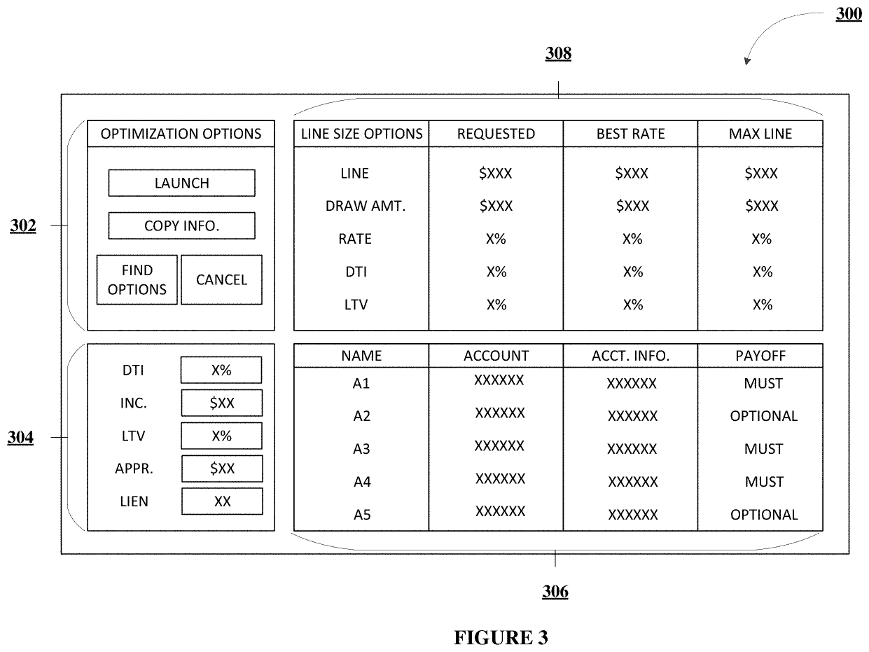

FIG. 3 illustrates a snapshot of a user interface associated with an application configured to execute an optimization algorithm 300, in accordance with an embodiment of the invention. As shown in FIG. 3, the snapshot comprises optimization options 302 capable of launching the optimization process, information associated with the resource capacity of the user 304, one or more resources associated with the resource utilization profile of the user 306, and information associated with the additional resource requested by the user and one or more alternative resources 308.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for an intelligent resource deployment counteroffer system, the system comprising:
at least one non-transitory storage device; and
at least one processing device coupled to the at least one non-transitory storage device, wherein the at least one processing device is configured to:
electronically receive, from a computing device associated with a user, a request for one or more additional resources to be deployed to the user;
retrieve information associated with a resource utilization profile associated with the user, wherein the resource utilization profile comprises a resource capacity;
determine that a deployment of the one or more additional resources to the user will exceed the resource capacity;
initiate one or more optimization algorithms on the resource utilization profile, the one or more additional resources, and one or more alternative resources to determine at least one favorable alternative resource to the one or more additional resources;
determine a counteroffer associated with the deployment of the one or more additional resources based on at least determining the at least one favorable alternative resource; and
transmit control signals configured to cause the computing device associated with the user to display the counteroffer to the user.

2. The system of claim 1, wherein the at least one processing device is further configured to:
electronically receive, from the computing device, the request for one or more additional resources to be deployed to the user, wherein the one or more additional resources comprises at least a new line of credit with a first entity, wherein the new line of credit comprises at least a line amount and an interest rate;
receive information associated with the resource utilization profile of the user, wherein the resource utilization profile comprises at least an existing line of credit of the user with one or more entities, an annual income of the user, and assets and liabilities of the user; and
determine the resource capacity of the user based on at least the information associated with the resource utilization profile of the user, wherein determining the resource capacity further comprises determining a lending score associated with the user, wherein the lending score is indicative of an eligibility of the user to receive the new line of credit.

3. The system of claim 2, wherein the at least one processing device is further configured to:
determine based on at least the lending score, that the user is not eligible to receive the new line of credit with the first entity, wherein determining further comprises comparing the lending score of the user with a predetermined eligibility score;
receive information associated with the one or more alternative resources, wherein the one or more alternative resources comprises at least one of an alternative line of credit, wherein the alternative line of credit comprises at least an alternative line amount and an alternative interest rate; and
initiate the one or more optimization algorithms on the information associated with the resource utilization profile of the user, the one or more alternative resources, and information associated with the new line of credit to determine at least one favorable alternative line of credit to the new line of credit, wherein the at least one favorable alternative line of credit comprises an optimal alternative line of credit for the user.

4. The system of claim 3, wherein the one or more optimization algorithms are configured to determine the optimal alternative line of credit by minimizing the alternative interest rate and maximizing the alternative line amount while keeping the lending score lower than the predetermined eligibility score to determine an optimal alternative line amount and an optimal alternative interest rate.

5. The system of claim 4, wherein the at least one processing device is further configured to determine a first set of actions to be executed by the user to receive the optimal alternative line amount at the optimal alternative interest rate.

6. The system of claim 5, wherein the first set of actions comprises at least paying off at least a portion of the existing line of credit.

7. The system of claim 5, wherein the at least one processing device is further configured to:
electronically receive, from the computing device of the user, an indication that the user has executed at least a portion of the first set of actions;
determine the lending score of the user based on at least receiving the indication that the user has executed at least the portion of the first set of actions;
determine whether the lending score of the user is greater than the predetermined eligibility score; and
determine that the user is eligible to receive the optimal alternative line amount at the optimal alternative interest rate based on at least determining that the lending score of the user is greater than the predetermined eligibility score.

8. The system of claim 3, wherein the at least one processing device is further configured to:
electronically receive, from the computing device of the user, a preferred interest rate for the optimal alternative line amount;
initiate the one or more optimization algorithms on the information associated with the resource utilization profile of the user, the one or more alternative resources, and the preferred interest rate to determine the optimal alternative line of credit for the user, wherein the optimal alternative line of credit comprises the optimal alternative line amount and the preferred interest rate; and
determine a second set of actions to be executed by the user to receive the optimal alternative line amount at the preferred alternative interest rate, wherein the second set of actions comprises at least paying off a portion of the existing line of credit.

9. The system of claim 8, wherein the at least one processing device is further configured to:
electronically receive, from the computing device of the user, an indication that the user has executed at least a portion of the second set of actions;
determine the lending score of the user based on at least receiving the indication that the user has executed at least the portion of the second set of actions;
determine whether the lending score of the user is greater than the predetermined eligibility score; and
determine that the user is eligible to receive the optimal alternative line amount at the preferred alternative interest rate based on at least determining that the lending score of the user is greater than the predetermined eligibility score.

10. The system of claim 8, wherein the at least one processing device is further configured to:
electronically receive, from the computing device of the user, a preferred set of actions the user is willing to execute to receive the new line of credit;
determine the lending score of the user based on at least receiving the preferred set of actions the user is willing to execute to receive the new line of credit;
determine whether the lending score of the user is greater than the predetermined eligibility score; and
determine that the user is not eligible to receive the new line of credit based on at least determining that the lending score of the user is not greater than the predetermined eligibility score.

11. The system of claim 10, wherein the at least one processing device is further configured to initiate, based on at least receiving the indication that the user is willing to execute the preferred set of actions, the one or more optimization algorithms on the information associated with the resource utilization profile of the user, the one or more alternative resources, and information associated with the new line of credit to determine the optimal alternative line of credit for the user, wherein the optimal alternative line of credit comprises the optimal alternative line amount and the optimal alternative interest rate.

12. The system of claim 10, wherein the at least one processing device is further configured to initiate a presentation of a user interface for display on the computing device of the user, wherein the user interface comprises the counteroffer, wherein the counteroffer further comprises the optimal alternative line of credit.

13. A computer program product for an intelligent resource deployment counteroffer system, the computer program product comprising a non-transitory computer-readable medium comprising code causing a first apparatus to:
electronically receive, from a computing device associated with a user, a request for one or more additional resources to be deployed to the user;
retrieve information associated with a resource utilization profile associated with the user, wherein the resource utilization profile comprises a resource capacity;
determine that a deployment of the one or more additional resources to the user will exceed the resource capacity;
initiate one or more optimization algorithms on the resource utilization profile, the one or more additional resources, and one or more alternative resources to determine at least one favorable alternative resource to the one or more additional resources;
determine a counteroffer associated with the deployment of the one or more additional resources based on at least determining the at least one favorable alternative resource; and
transmit control signals configured to cause the computing device associated with the user to display the counteroffer to the user.

14. The computer program product of claim 13, wherein the first apparatus is further configured to:
electronically receive, from the computing device, the request for one or more additional resources to be deployed to the user, wherein the one or more additional resources comprises at least a new line of credit with a first entity, wherein the new line of credit comprises at least a line amount and an interest rate;
receive information associated with the resource utilization profile of the user, wherein the resource utilization profile comprises at least an existing line of credit of the user with one or more entities, an annual income of the user, and assets and liabilities of the user; and
determine the resource capacity of the user based on at least the information associated with the resource utilization profile of the user, wherein determining the resource capacity further comprises determining a lending score associated with the user, wherein the lending score is indicative of an eligibility of the user to receive the new line of credit.

15. The computer program product of claim 14, wherein the first apparatus is further configured to:
determine based on at least the lending score, that the user is not eligible to receive the new line of credit with the first entity, wherein determining further comprises comparing the lending score of the user with a predetermined eligibility score;
receive information associated with the one or more alternative resources, wherein the one or more alternative resources comprises at least one of an alternative line of credit, wherein the at least one alternative line of credit comprises at least an alternative line amount and an alternative interest rate; and
initiate the one or more optimization algorithms on the information associated with the resource utilization profile of the user, the one or more alternative resources, and information associated with the new line of credit to determine at least one favorable alternative line of credit to the new line of credit, wherein the at least one favorable alternative line of credit comprises an optimal alternative line of credit for the user.

16. The computer program product of claim 15, wherein the one or more optimization algorithms are configured to determine the optimal alternative line of credit by minimizing the alternative interest rate and maximizing the alternative line amount while keeping the lending score lower than the predetermined eligibility score to determine an optimal alternative line amount and an optimal alternative interest rate.

17. The computer program product of claim 16, wherein the first apparatus is further configured to determine a first set of actions to be executed by the user to receive the optimal alternative line amount at the optimal alternative interest rate.

18. The computer program product of claim 17, wherein the first set of actions comprises at least paying off at least a portion of the existing line of credit.

19. The computer program product of claim 16, wherein the first apparatus is further configured to:
electronically receive, from the computing device of the user, an indication that the user has executed at least a portion of the first set of actions;
determine the lending score of the user based on at least receiving the indication that the user has executed at least the portion of the first set of actions;
determine whether the lending score of the user is greater than the predetermined eligibility score; and
determine that the user is eligible to receive the optimal alternative line amount at the optimal alternative interest rate based on at least determining that the lending score of the user is greater than the predetermined eligibility score.

20. A computer implemented method for an intelligent resource deployment counteroffer system, the method comprising:
electronically receiving, from a computing device associated with a user, a request for one or more additional resources to be deployed to the user;
retrieving, using a computing device processor, information associated with a resource utilization profile associated with the user, wherein the resource utilization profile comprises a resource capacity;
determining, using a computing device processor, that a deployment of the one or more additional resources to the user will exceed the resource capacity;
initiating, using a computing device processor, one or more optimization algorithms on the resource utilization profile, the one or more additional resources, and one or more alternative resources to determine at least one favorable alternative resource to the one or more additional resources;
determining, using a computing device processor, a counteroffer associated with the deployment of the one or more additional resources based on at least determining the at least one favorable alternative resource; and
transmitting, using a computing device processor, control signals configured to cause the computing device associated with the user to display the counteroffer to the user.
